(19) United States
(12) Patent Application Publication
(10) Pub. No.: US 2013/0040561 A1
(43) Pub. Date: Feb. 14, 2013

(54) SYSTEM AND METHOD FOR LAUNCHING AND/OR DOWNLOADING APPLICATIONS WITH NEAR FIELD COMMUNICATION TAGS

(71) Applicants: Ivo Conde e Silva, Lisbon (PT); Paulo Jorge Passos Salgado, Lisbon (PT)

(72) Inventors: Ivo Conde e Silva, Lisbon (PT); Paulo Jorge Passos Salgado, Lisbon (PT)

(21) Appl. No.: 13/209,016

(22) Filed: Aug. 12, 2011

(51) Int. Cl. H04B 5/02

(52) U.S. Cl. 455/41.1

(57) ABSTRACT

One or more applications are registered, managed, launched and/or downloaded using one or more near field communication (NFC) tags. In one embodiment, a NFC application is launched based on detection of a smart code that is in an NFC tag. The NFC application may be configured to write and/or assign a smart code to one or more tags. Another embodiment is directed to a web portal that may be accessed by the NFC application to download applications for presenting data associated with a tag. The NFC application may launch an application based on device placement in proximity to a NFC tag without user interaction, and also allow for writing and/or associating smart codes to NFC tags. The system and methods may overcome or at least ameliorate memory storage capacity limitations in a tag, and may advantageously reduce time and the need of user interaction when opening an application.

### FIELD

The present disclosure relates generally to near field communication (NFC) devices and methods, and more particularly to a system and methods for launching applications, and for downloading applications, based on near field communication.

### BACKGROUND

Near field communication (NFC) is a short-range wireless connectivity technology used for information services. NFC can allow for contactless identification, such as Radio Frequency Identification (RFID), and may be implemented in various types of electronic devices for short range communication. Exemplary features of NFC include read/write operation, peer-to-peer communication, and card emulation. Card emulation may be useful for contactless payments and ticketing applications. As an emerging technology on personal electronic devices, NFC can be used to serve multiple purposes including making payments.

One of the drawbacks of known methods and devices that utilize NFC is the storage capacity of NFC tags. Passive NFC tags, for example, have limited data storage. Active NFC tags may be expensive or difficult to implement in many situations. Moreover, both active and passive NFC tags typically do not provide or specify an application in order for a device to utilize data associated with the NFC tag. Similarly, a specific application may be required to read data associated with a tag. Accordingly, there is a desire for a platform to provide applications to devices. Similarly, there is a desire for a system that allows for management of connection to NFC tags and managing applications for utilizing NFC tags that overcomes one or more of the aforementioned drawbacks and provides useful technological solutions and functionality that may improve user experience of NFC systems.

### BRIEF SUMMARY OF EMBODIMENTS

Disclosed herein are a system and methods for not only launching applications but also for downloading applications if not presented to be launched. In one embodiment, a method includes detecting a tag, by a device, based on near field communication (NFC) between the device and the tag, and receiving data from the tag, the data including a smart code. The method further includes identifying an application associated with the smart code, and launching the application by the device based on the smart code, or downloading and then launching the application based on the smart code. According to one embodiment, the application may relate to a service associated with the tag. Other aspects, features, and techniques will be apparent to one skilled in the relevant art in view of the following detailed description.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a system for registering and launching applications according to one or more embodiments;

FIG. 2 depicts a process for launching an application according to one or more embodiments;

FIG. 3 depicts a simplified block diagram of a device according to one embodiment;

FIG. 4 depicts a process for writing a smart code to a tag according to one or more embodiments;

FIG. 5 depicts a graphical representation of network based services that may be provided to one or more users;

FIG. 6 depicts a graphical representation of NFC application features according to one or more embodiments;

FIG. 7 depicts a graphical representation of device operation according to one or more embodiments;

FIGS. 8A-8B depict graphical representations of detecting a tag according to one or more embodiments; and

FIG. 9 depicts a process for launching an application according to one or more embodiments.

### DETAILED DESCRIPTION OF EXEMPLARY EMBODIMENTS

### Overview and Terminology

One aspect of the disclosure relates to managing and providing applications for interfacing with near field communication (NFC) tags. One embodiment of the disclosure is directed to providing a platform for users to register NFC devices and launch or download applications by a network based system, such as a web portal. Another embodiment is directed to an NFC application for devices to launch one or more applications when an NFC tag is detected. In another embodiment, smart codes are provided for identifying and managing applications for interfacing with NFC tags. Smart codes, as used herein, relate to a set of characters for identifying one or more applications. One advantage of using smart codes, as described herein, may be the ability to overcome the storage capacity of NFC tags and provide users of NFC devices a means for launching applications utilizing data stored by NFC tags. One or more of the embodiments described herein relate to systems and applications for associating smart codes with NFC tags.

As used herein, near field communication or NFC refers to a short-range wireless connectivity for exchange of data between devices over small distances (e.g., distances less than 15 cm). NFC may operate at a frequency of 13.56 MHz and transfer data up to 242 Kbits/sec and provides both read and write operations. Although the disclosure is described relating to NFC, it should be appreciated that the principles of the disclosure may be applied to and include other forms of short range communication relative to devices.

In one embodiment, a system is provided to allow one or more devices to communicate with a server for registration of NFC devices. The server may support a system by which registered users can download applications and manage device settings for interfacing with particular types of NFC tags. In a preferred embodiment, the server does not store applications and does not manage device settings, but the server does manage applications which are registered in the server. According to this aspect of the embodiment, the registered applications are not saved on the server. Instead, for each application, the server saves the name of the application and the link where it can be downloaded (for example, Android Market, Iphone AppStore, Nokia OviStore, etc.).

The system may provide services to registered and non-registered users of NFC devices. In one embodiment, the system may allow for users to assign smart codes to one or more NFC tags and allow NFC devices to select applications for services associated with NFC tags. In addition, the system may be configured to allow a user to modify one or more device settings, applications, and assign smart codes to one or more NFC tags.

Another embodiment is directed to a method for launching an application on a device based on a detected NFC tag. NFC devices may be provided with an application, or NFC application, to detect NFC codes and launch one or more applications based on a smart code detected in the NFC tag. In one embodiment, the NFC application may be configured to launch an application when an NFC tag is detected based on a smart code associated with the NFC tag. The NFC application may be a background application that detects NFC devices and tags, and launches applications without requiring a user to request presentation of the application. The NFC application may launch a particular application to interface with the detected NFC tag. By way of example, the application allows the device to launch applications simply by making contact, or by NFC with, a NFC tag. The NFC application can provide means for launching an application that is simple and fast. In certain embodiments, the NFC application must write a smart code to an NFC tag before an application may be launched. The NFC application may provide users access to a network based server, or web portal, for specifying applications associated with NFC tags.

According to another embodiment, the systems and methods described herein may provide a secure means for protecting data stored on a device. NFC devices as described herein may be configured to store a secure element in one or more of a SIM card, memory card, chip or memory of a device. NFC devices may include a security key or code to allow for payment or authentication of a user. The security key or code may be employed by an NFC application, application associated with a tag, or device associated with a tag (e.g., banking terminal, payment kiosk, etc.) for authenticating a device and/or user.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a non-transitory medium, etc.

### Exemplary Embodiments

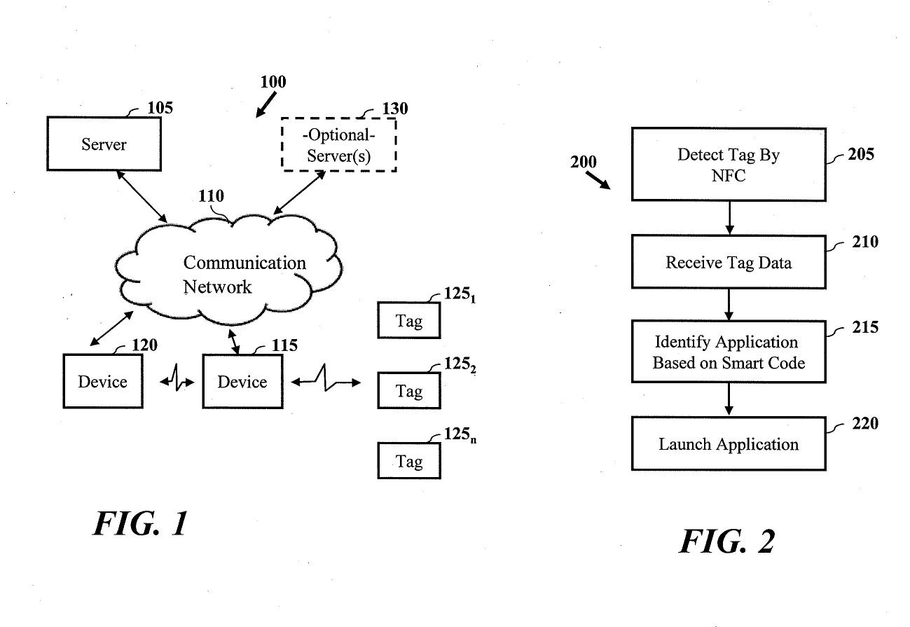

Referring now to the figures, FIG. 1 depicts a graphical representation of a system for managing device applications and settings according to one or more embodiments. As depicted in FIG. 1, system 100 includes server 105, communication network 110, device 115, device 120 and tags 125₁₋ₙ. In one embodiment, system 100 may allow for registering and managing near field communication (NFC) tags for one or more devices.

Server 105 may be configured to communicate with one or more devices by way of communication network 110 to provide access and management to one or more applications for interfacing with a NFC tag. In one embodiment, server 105 may provide a web portal to provide access to applications for reading and presentation of data associated with tags. Server 105 may additionally be configured to allow for management of smart codes and applications.

Communication network 110 may allow for one or more of wired and wireless communication. For example, communication network 110 may allow for network based communications including, but not limited to, LAN, WAN, WI-FI, etc. Devices 115 and 120 of FIG. 1 may be configured to connect to server 105 via communication network 110, which may include wired and/or wireless components.

In one embodiment, system 100 may allow for one or more devices to communicate with server 105. Devices of system 100 may be configured to communicate with other devices and/or NFC tags. By way of example, device 115 may be configured for network communication with one or more network entities, such as server 105 and one or more third party servers via communication network 110. Device 115 may additionally be configured for read/write operation of NFC tags, peer-to-peer communication with another device, such as device 120, and payment emulation. Device 115 may be or relate to one or more devices configured for NFC. For example, device 115 may be or relate to one or more of a personal communication device, media player, imaging device, or mobile electronic device in general. Device 115 may be configured to store an NFC application and one or more applications to present data associated with tags.

According to one embodiment, device 115 may be configured to launch an application based on a near field communication with another device, such as device 120. Device 115 may similarly launch an application based on NFC with one or more of tags 125₁₋ₙ. Device 115 may be employed to create, access, and/or manage one or more connections via a network connection or with NFC. Access and management of applications for device 115 may be based on registration, or an account, with server 105. In certain embodiments, registration with server 105 by device 115 may allow for greater access to features and applications.

Device 120 may relate to a device associated with a user or service different from the user of device 115. Alternatively, device 120 may be a different or second device of the user associated with device 115. Device 120 may configured to operate similarly to device 115. Devices 115 and 120 may be configured for near field communication and may each include a tag. In certain embodiments, devices 115 and 120 may be active devices configured to read data associated with another device or tag. According to one embodiment, device 115 may be configured to access data from device 120 based on NFC. Communication relative to devices 115 and 120 may be based on a smart code associated with each device. In certain embodiments, device 115 may assigned a smart code to device 120. Device 120 may similarly assign a smart code to device 115.

Acceding to another embodiment, device 115 of system 100 may be configured to launch an application based on NFC with one or more of tags 125₁₋ₙ. Device 115 may be configured to store and run an NFC application to access a web portal and launch one or more applications for providing services or reading data associated with a tag, and also to download one or more applications if not presented to be launched. The application may allow for interfacing with device 120, one or more of tags 125, and server 105. As will be described herein, the NFC application may allow a user of device 115 to associate, or write, a smart code to one or more devices or tags configured for NFC. One advantage of associating a smart code with a device configured for NFC may be the ability to launch an application by device 115 by placement of the device in contact with or near to another device or tag configured for near field communication. Another advantage may be the ability to specify and launch a desired application for certain tags.

According to another embodiment, users of system 100 may create, access, and/or manage an account with server 105 by an NFC application of device 115. According to another embodiment, management of applications desired by a user may be based on a service account. Once a service account is created by the user, the user may access the service account from server 105 to manage applications, user information, etc.

Tags 125₁₋ₙ may be configured to store a unique identifier and data for one or more services, such as a network address and smart codes. Each tag 125 may have only one smart code. Data storage limitations of known tags may be overcome by assigning or writing a smart code to tags 125₁₋ₙ. One advantage of the embodiments described herein may be the ability to assign an application for presenting data or services based on data stored by the tag. Tags 125₁₋ₙ may be associated with one or more locations and services. For example, in one embodiment, tags 125₁₋ₙ may be placed in a public location to allow a user to conduct an electronic transaction including, but not limited to, banking, purchasing, requesting a refund, bill payment, ordering a service, receiving media, etc.

Other uses may include placing tags in association with services or content, such as advertisements, marketing material, posters, public areas, public transportation locations, atm's, and businesses. Similarly tags may be employed to provide access to information associated with a particular location, travel information, check-in to a location, rental services, and rewards programs. Due to a wide array of uses for tags, it is desirable to assign particular applications to one or more tags. It is additionally advantageous to provide a means for allowing a user to access and process data associated with tags with minimal set-up once a tag is detected. The various embodiments and methods described below allow for registration of a device, and management of communication of the device with one or more tags and other devices.

Although system 100 is described above as having a single server in FIG. 1 for management of applications, it may be appreciated that system 100 include a plurality of servers such as optional server 130. Optional server 130 may be configured to provide a web portal for registration of devices, access to applications and assigning smart codes to tags 125₁₋ₙ. A web portal provided by system 100 may allow for changes to a user's device settings or assignment of smart codes when required. Alternatively, optional server 130 may relate to one or more third party services for providing data or services associated with a tag.

Although system 100 of FIG. 1 is described above as relating to NFC, it should be appreciated that system 100 and the embodiments of the disclosure described herein are not limited to NFC, but may be applied to forms of short range wireless communication in general.

Referring now to FIG. 2, a process is depicted for launching an application according to one or more embodiments. Process 200 may be employed by a device (e.g., device 115) to detect and interface with one or more NFC devices and NFC tags. In certain embodiments, process 200 may be performed by an NFC application stored on a device, the NFC application being separate from one or more applications identified based on a smart code. Process 200 may be initiated at block 205 by detecting a tag based on near field communication (NFC) between the device and the tag. In an exemplary embodiment, communication between two NFC compatible devices may occur when the devices are brought within a short distance (e.g., 0-15 cm) and/or touch for a brief period of time. The tag may be one of an active NFC tag and passive NFC tag. The tag may also be configured to store a smart code and data for the service.

NFC communication at block 205 may be based on the NFC Data Exchange Format (NDEF) to define a format for exchanging information between two NFC devices. NDEF is a binary message format that may be employed to encapsulate one or more application-define payloads of arbitrary type and size into a single message construct. Each payload of a tag may be described by a type, length and optional identifier. Type identifiers may include uniform resource identifier (URI), multipurpose internet mail extensions (MIME) media types or NFC specific types.

In certain embodiments, process 200 may include writing a smart code to the tag using NFC to associate an application with the tag. Prior to launching an application to present data associated with a smart code, the NFC application may require that a smart code is assigned to, or stored by, the tag. As such, a smart code may be written or assigned to the tag using an NFC application. In one embodiment, the smart code is stored by the tag. In another embodiment, the smart code may be assigned to a unique identifier of the tag, the tag storing the unique identifier and data associated with a service. According to another embodiment, users of a device may be required to login to a web portal to select and register applications for a tag that may be downloaded or assigned to process data stored by the tag. It may also be appreciated that a smart code may be received by user interface of an NFC application when the smart code cannot be detected based on NFC with the tag.

At block 210, data may be received from the tag. The received data may provide a smart code. For example, the smart code may identify a browser or user interface application for displaying a website or network address identified by a tag. The smart code may include a plurality of alphanumeric characters to identify a particular application. An application may be identified at block 215 by selecting an application stored on the device based on the smart code. In certain embodiments, identifying an application at block 215 includes requesting identification of one or more applications, by the device, from a server based on the smart code, and downloading a user selected application to the device.

Associating the smart code with the application may require registration of the device with a network server. In certain embodiments, a smart code may be employed for different applications of different operating systems. For example, a smart code may be assigned to launch a financial application on an operating system of a mobile device, or may launch a gaming application on a different computer operating platform.

The application may be launched by the device based on the smart code at block 220. Launching the application may allow for presentation of data for one or more services associated with the tag. Launching an application can include providing at least one of a graphical element and graphical interface associated with the application by the device. The application provides a user interface for the service associated with the tag, the tag allowing for one or more of a transaction, receiving marketing data, receiving information associated with a particular location, travel check-in, rental services, payments, entertainment and dining. Although process 200 is described as being performed by a device, it should be appreciated that the process may be performed by an NFC application stored by the device.

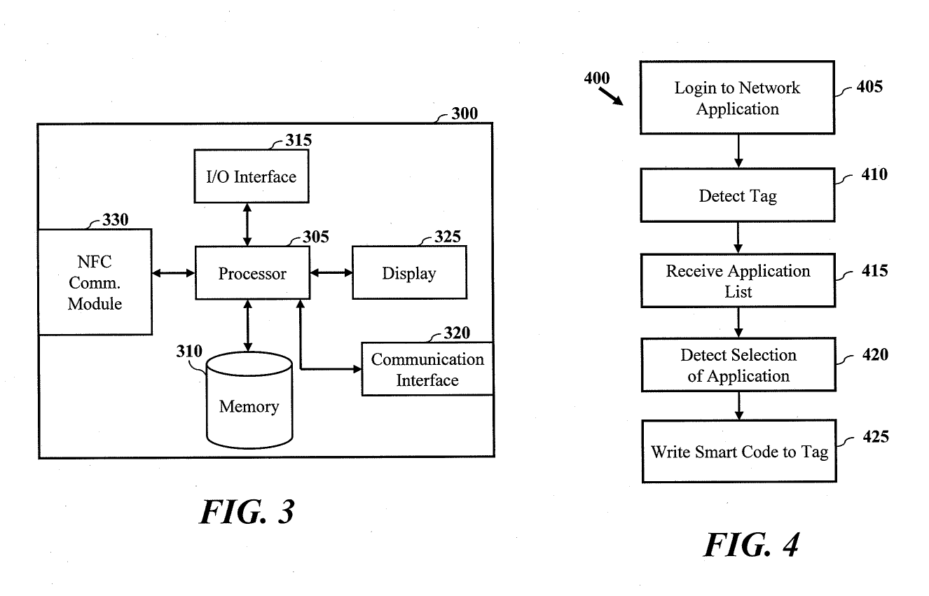

Referring now to FIG. 3, a simplified block diagram is depicted of a device according to one embodiment. Device 300 may relate to one or more of personal communication device, media player, imaging device, or mobile electronic device in general. In certain embodiments, device 300 is or relates to device 115 of FIG. 1. Device 300 may be configured to provide an application for communicating with one or more tags and managing one or more applications that may be launched by the device. In another embodiment, device 300 may be configured to access a server to allow for network based management of device applications and features.

As depicted in FIG. 3, device 300 includes processor 305, memory 310, input/output (I/O) interface 315, communication interface 320, display 325 and near field communications (NFC) module 330. Elements of device 300 may be configured to communicate and interoperate with processor 305 by a communication bus. Processor 305 may be configured to control operation of device 300 based on one or more computer executable instructions stored in memory 310. In one embodiment, processor 305 may be configured to control output of audio and video data, and run one or more applications based on a detected NFC tag. Memory 310 may relate to one of RAM and ROM memories and may be configured to store one or more files, and computer executable instructions for operation of device 300. Although depicted as a single memory unit, memory 310 may relate to one or more of internal device memory and removable memory. Memory 310 may store one or more audio and video files.

Input output (I/O) interface 315 may be configured to output data and/or commands to one or more output devices. According to one embodiment, I/O interface 315 may be configured to receive one or more user commands. I/O interface 315 may include one or more buttons to control operation of device 300 including controlling selection of content for display and controlling operation of device 300. Input buttons of I/O interface 315 may include one or more buttons for user input, such as a numerical keypad, volume control, menu controls, pointing device, track ball, mode selection buttons, and playback functionality (e.g., play, stop, pause, forward, reverse, slow motion, etc). Input buttons of I/O interface 315 may include hard and soft buttons, wherein functionality of the soft buttons may be based on one or more applications running on device 300.

Communication interface 320 may include one or more elements to allow for communication by device 300 via wired or wireless communication. Communication interface 320 may include one or more ports for receiving data, including ports for removable memory. Communication interface 320 may be configured to allow for network based communications including but not limited to LAN, WAN, Wi-Fi, etc.

In certain embodiments, device 300 may include display 325 to display image data, such as video data and graphics data, and display one or more applications executed by processor 305.

NFC communication module 330 may be configured to allow device 300 to communicate with one or more tags (e.g., tags 125₁₋ₙ) and one or more devices (e.g., device 120). In certain embodiments, NFC communication module 330 may be configured to detect a tag associated with a smart code and data associated with a service. NFC communication module 330 may additionally be configured to write a smart code to a tag. In certain embodiments, NFC communication module 330 may include one or more of active and passive NFC tags to allow for communication with other devices and tags.

Referring now to FIG. 4, a process is depicted for writing a smart code to a tag. Smart codes, as described herein, may be employed to overcome one or more drawbacks of known NFC tags and devices including storage capacity of a tag. In one embodiment, a smart code may include a series of three fixed characters followed by four alphanumeric characters comprised of a combination of lower and upper case letters, numbers (e.g., 0-9). In certain embodiments, the embodiments described herein may provide 15 million possible smart codes. Each smart code may be assigned to identify an application for one or more operating systems of a device. By providing a smart code for a tag, applications may be automatically launched by a device when the tag is detected by NFC communication.

Process 400 may be initiated by login to a server (e.g., server 105) at block 405. Login may require a user to register and create an account for access to the web portal. Process 400 may continue with detection of a tag at block 410. The device may detect a tag based on NFC. Based on detection of a tag at block 410, the device may access a server to retrieve a list of one or more applications that may be employed to interface with the particular tag at block 415. The list of applications may be presented to a user by a display of the device. The device may detect a user selection of an application at block 420. Based on a selection of an application, the device may be configured to write a smart code to the tag. In certain embodiments, the smart code may be written to the tag such that the tag is configured to store the smart code at block 425. Following a smart code writing to the tag, subsequent detections of the tag by a device may launch an application associated with the smart code on the device.

According to one embodiment, writing smart code to a tag requires a user to login to a server using a NFC application. In certain embodiments, writing a smart code to a tag may include storing the smart code on the tag. In other embodiments, writing a smart code to a tag may include associating a unique identifier of a tag with a smart code on a device, wherein detection of a unique identifier of a tag triggers identification of the smart code on the device and launch of an application associated with the smart code. Based on a successful login, the NFC application may display a list of the applications already registered on the web portal that can be written or associated with a NFC tag. In certain embodiments, a smart code may be displayed near a NFC tag.

According to one embodiment, a NFC application does not need to be running in the foreground of a device to launch applications. For example, as long as a tag is detected, an application associated with the smart code may be launched. If the tag is not recognized, a user interface may allow for configuration to receive a smart code from a user and present a list of applications that may be selected to present data associated with a tag.

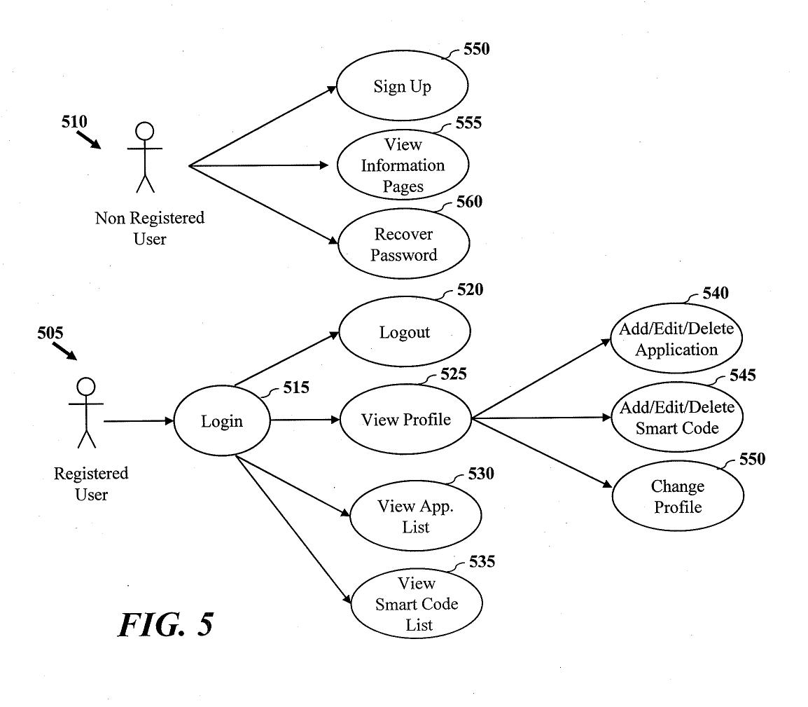

Referring now to FIG. 5, a graphical representation is depicted of network based services that may be provided to one or more users according to one or more embodiments. In one embodiment, services depicted in FIG. 5 may relate to features of a web portal provided by the server (e.g., server 105) of FIG. 1. Network based services of FIG. 5 may include services 505 provided to a registered user and services 510 provided to non-registered users. Registered user services 505 require a user of a device (e.g., device 115) to register. Registration can provide a user with login 515 to manage one or more applications for a device. Login by a user may be based on a user identifier and password generated during registration. Registration may also allow for a server to store an identifier of a NFC module associated with a device.

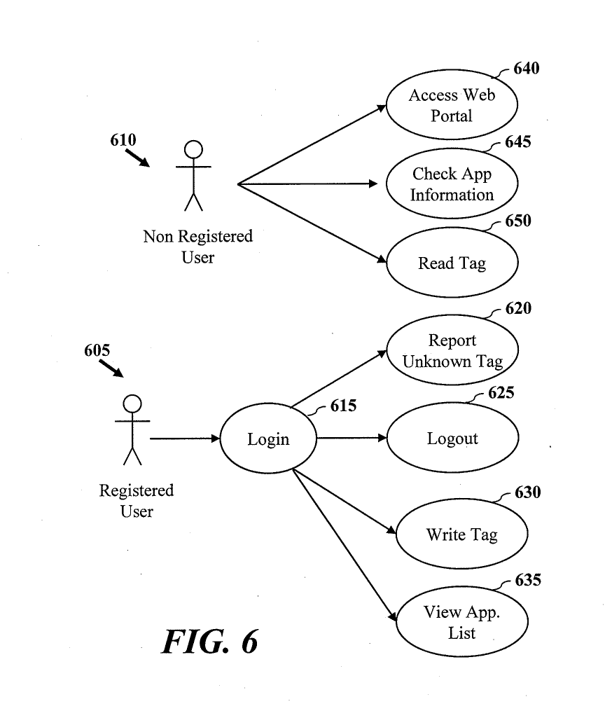

Login to the web portal may be provided by an NFC application running on a user device, the features of which will be described in more detail below with respect to FIG. 6. Based on an accepted login, the web portal application may provide logout feature 520 to disconnect the device from the web portal. View profile feature 525 may allow a user to view and manage one or more details of a user account or profile including a name, identification of one or more devices, accounts, etc. View application list feature 530 may allow for a user to view applications stored on the device, and the association of one or more smart codes to applications. View smart code list feature 535 may allow for a user to view one or more smart codes and tags associated with a device.

As depicted in FIG. 5, view profile feature 525 may allow a user to add, edit, and/or delete an application as depicted by 540, add, edit, and/or delete a smart code as depicted by 545, and change profile as depicted by 550. Services provided by view profile feature 525 may allow a user to manage account settings and one or more device connections.

Registered users may additionally be provided with non-registered user features 510. Non-registered user features 510 do not require user registration. Non-registered user features 510 may include a sign up feature 550 to allow a user to register and for access to the web portal. View information pages feature 555 allows for users to view data associated with a scanned tag. Recover password feature 560 can allow a user to obtain a password to allow for login.

According to one embodiment, a NFC application may be provided to a user device to allow users to access a web portal and to provide access to one or more applications based on detection of a tag. The NFC application may allow for one or more services for registered and non-registered users. Referring now to FIG. 6, a graphical representation is depicted of features of a NFC application according to one or more embodiments.

NFC application features of FIG. 6 may include features 605 provided to a registered user and features 610 provided to non-registered users. Registered user features 605 require registration of a device (e.g., device 115) or user. Login feature 615 provides a user of the device access to one or more features not available to non-registered users. Based on an accepted login, the NFC application may provide a report unknown tag feature 620 to notify a server of one or more tags which are not recognized by the device. When a tag is not recognized, the NFC application may generate a form in which the user can insert appropriate information, such as information about the tag. Logout feature 625 may be used to disconnect connection of a user device to a web portal. Write tag feature 630 may allow for writing or assigning a smart code for a tag. View application list feature 635 may allow a user to view one or more applications stored on the device which may be employed to read and/or process data provided by a tag or other NFC device.

Non-registered features 610 may include an access web portal feature 640 to allow a user to access web portal features as described above in connection with FIG. 5. Check application information feature 645 allows users to request and receive information associated with an application for a particular tag. Read tag feature 650 allows users to detect and receive data from one or more active or passive tags. Non-registered features 610 may be provided to registered users with or without login.

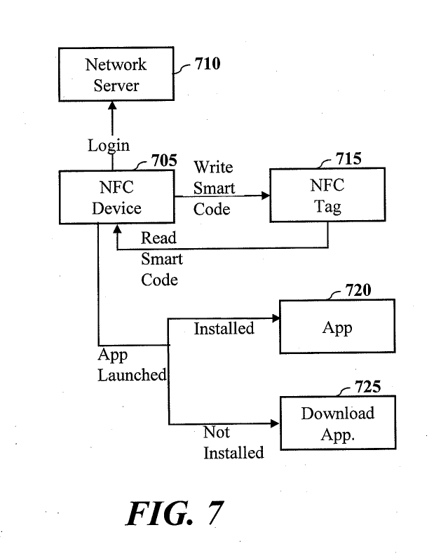

Referring now to FIG. 7, a graphical representation is depicted of device operation according to one or more embodiments. Device 705 relates to a NFC device configured to detect one or more NFC tags. NFC device 705 may be configured for peer to peer communication with one or more other NFC devices. NFC device 705 may access network server 710 with one or more web portal features as described above in connection with FIG. 5. Access to network server 710 by NFC device 705 may require login and/or registration. NFC device 705 may be configured to read smart code data from and write smart code data to NFC tag 715. Based on smart code data read from NFC tag 715, NFC device 705 may launch one or more applications. When an application is installed on NFC device 705, the application may be launched as depicted by block 720. When an application is not installed on NFC device 705, the NFC device may download the application at block 725 based on login with network server 710. An important aspect of the described embodiment is that it makes it possible to download applications. The downloads are accomplished by the markets of the various operative systems.

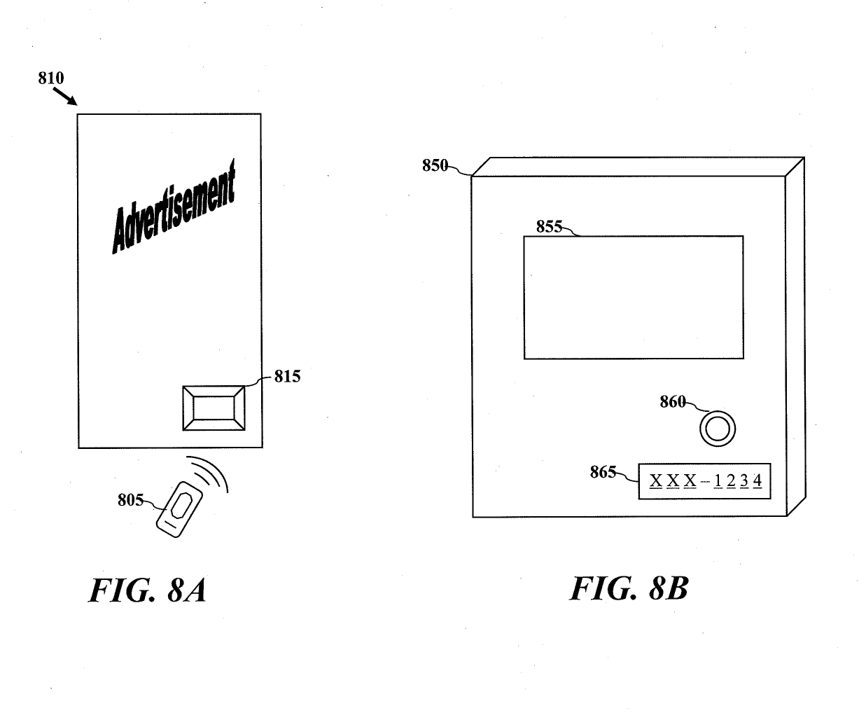

Referring now to FIGS. 8A-8B, graphical representations are depicted of detecting a tag according to one or more embodiments. Referring first to FIG. 8A, a device 805 is depicted according to one or more embodiments. Device 805 may be configured to detect a tag associated with one or more particular locations or services. As depicted in FIG. 8A, device 805 may detect tag 815 associated with a portion of advertisement 810. Advertisement 810 may be in a public location and associated with a particular subject. The purpose of the tag 815 may be to start a process by which the user of the device 805 is provided with information associated with advertisement 810. In one embodiment, device 805 may be configured to detect tag 815 and detect a smart code stored by tag 815. Based on the smart code received from tag 815, device 805 may be configured to launch an application associated with data for a service associated with a tag, and thereby provide the desired information to the user of the device. Tag 815 may relate to a passive tag. Although FIG. 8A is discussed as relating to an advertisement, it should be appreciated that the features described may be associated with other services or locations in public and private locations.

Referring now to FIG. 8B, a graphical representation is depicted of service station 850. Service station 850 may relate to one or more of a kiosk, terminal, information station, advertisement station, payment center, etc. Service station 850 may include a display 855 and NFC tag 860. NFC tag 860 may be an active NFC tag configured to read data from one or more of active and passive NFC tags, and configured for peer-to-peer communication with an NFC device. According to one embodiment, detection of tag 860 by an NFC device (e.g., device 115) may initiate launching (or downloading) of an application. In certain embodiments, a smart code may be displayed or presented near a tag, such as tag 860. Smart code 865 may be entered into a device to allow for an application to be specified and downloaded for interfacing with tag 860. As depicted, smart code 865 includes a string of characters including alphanumeric values.

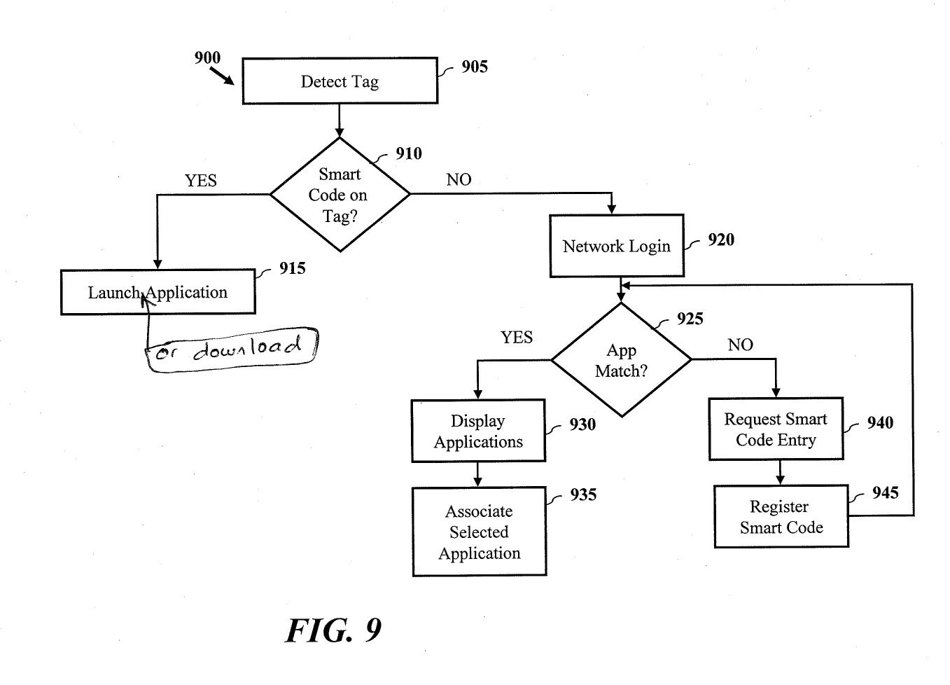

Referring now to FIG. 9, a process is depicted for launching or downloading an application according to one or more embodiments. Process 900 may be initiated by detection of a tag at block 905. Based on the detected tag, a device running a NFC application may check if a smart code is provided by the tag at decision block 910. When a smart code is recognized by the NFC application (“YES” path out of decision block 910), the device can launch or download an application at block 915 associated with the smart code. When a smart code is not recognized by the NFC application (“NO” path out of decision block 910), the device may initiate network login at block 920. At decision block 925, the device may check for an application match.

When an application match is determined (“YES” path out of decision block 925), the device may display one or more applications at block 930 that may be employed with the tag detected at block 905. Process 900 may then continue to associate a selected application at block 935 based on user selection of the displayed applications. When a smart code is not recognized by the NFC application (“NO” path out of decision block 925), the application may request that a user enter a smart code at block 940. Process 900 may then continue to register the smart code at block 945 for the tag and search for an application match at decision block 925.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method of launching or downloading an application on or to a device, the method comprising the acts of:
detecting a tag, by a device, based on near field communication (NFC) between the device and the tag;
receiving data from the tag, the data providing a smart code;
identifying an application associated with the smart code; and
launching the application by the device based on the smart code, wherein the application presents the data for the service associated with the tag, or downloading the application if the application is not presented to be launched in the device.

2. The method of claim 1, wherein the tag is one of an active NFC tag and passive NFC tag, and the tag is configured to store the smart code.

3. The method of claim 1, wherein the smart code includes a plurality of alphanumeric characters.

4. The method of claim 1, wherein the smart code is associated with the application based on registration with a network server.

5. The method of claim 1, wherein identifying an application includes requesting identification of one or more applications, by the device, from a server based on the smart code and downloading a user selected application to the device.

6. The method of claim 1, wherein identifying an application includes selecting an application stored on the device based on the smart code.

7. The method of claim 1, wherein launching an application includes providing at least one of a graphical element and graphical interface associated with the application by the device.

8. The method of claim 1, wherein the application provides a user interface for the service associated with the tag, the tag being related to one or more of a transaction, receiving marketing data, receiving information associated with a particular location, conducting transactions, and providing a user interface.

9. The method of claim 1, further comprising writing a smart code to the tag, by the device, based on NFC, relative to the device and tag, to associate the application with the tag.

10. A device comprising:
a near field communication (NFC) module configured to detect a tag based on NFC between the device and the tag; and
a processor coupled to the NFC module and memory, the processor configured to
receive data from the tag, the data providing a smart code;
identify an application associated with the smart code; and
launch or download the application by the device based on the smart code,
wherein the application presents data for a service associated with the tag.

11. The device of claim 10, wherein the device is one or more of a set-top box, personal communication device, media player, gaming device or electronic device in general.

12. The device of claim 10, wherein the tag is one of an active NFC tag and passive NFC tag, and the tag is configured to store the smart code.

13. The device of claim 10, wherein the smart code includes a plurality of alphanumeric characters.

14. The device of claim 10, wherein the smart code is associated with the application based on registration with a network server.

15. The device of claim 10, wherein identifying the application includes requesting identification of one or more applications from a server based on the smart code and downloading a user selected application to the device.

16. The device of claim 10, wherein identifying the application includes selecting an application stored on the device based on the smart code.

17. The device of claim 10, wherein launching the application includes providing at least one of a graphical element and graphical interface associated with the application by the device.

18. The device of claim 10, wherein the application provides a user interface for the service associated with the tag, the tag allowing for one or more of a transaction, receiving marketing data, receiving information associated with a particular location, conducting transactions, and providing a user interface.

19. The device of claim 10, further comprising writing a smart code to the tag, by the device, based on NFC, relative to the device and tag, to associate the application with the tag.

20. A non-transitory computer-readable medium having stored therein computer executable code for launching an application on a device, the computer executable code comprising:
computer readable code to detect a tag based on near field communication (NFC) between the device and the tag;
computer readable code to receive data from the tag, the data providing a smart code;
computer readable code to identify an application associated with the smart code; and
computer readable code to launch the application by the device based on the smart code, wherein the application presents data for a service associated with the tag.
